(19) United States
(12) Patent Application Publication
(10) Pub. No.: US 2021/0355880 A1
(43) Pub. Date: Nov. 18, 2021

(54) METHOD OF USING ADDITIVELY MANUFACTURED ACOUSTIC PANELS USING FINE TUNED HELMHOLTZ RESONATORS FOR NOISE REDUCTION

(71) Applicant: The Boeing Company, Chicago, IL (US)

(72) Inventor: Tyler Emerson Berkey, Ladson, SC (US)

(73) Assignee: The Boeing Company, Chicago, IL (US)

(21) Appl. No.: 16/875,820

(22) Filed: May 15, 2020

(51) Int. Cl. F02C 7/24

(52) U.S. Cl. CPC F02C 7/24; B33Y 80/00

(57) ABSTRACT

An acoustic panel including an acoustic property varying as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

### CROSS REFERENCE TO RELATED APPLICATIONS

This application is related to co-pending and commonly assigned U.S. patent application Ser. No. XX/XXX,XXX, filed on same date herewith, by Tyler Berkey and entitled “METHOD FOR USING CONTOUR CORRECT THERMOPLASTIC CORE IN BONDED ACOUSTIC PANEL ASSEMBLY,” Applicant docket No. 19-2816-US-NP, which application is incorporated by reference herein.

### BACKGROUND

### 1. Field

The present disclosure relates to acoustic treatments and methods of making the same.

### 2. Description of the Related Art

FIG. 1 illustrates an exemplary aircraft engine 101 comprising a fan 100 having fan blades 100a, a low pressure (LP) compressor 102, a fan case 104, an engine casing 106, a High Pressure (HP) compressor 108, a HP turbine 110, a LP turbine 112, and a LP shaft 114 connecting the LP compressor 102 and the LP turbine 112. Also illustrated is an HP shaft 122 having longitudinal axis 128 connecting the HP turbine 110 and the HP compressor 108, transmission 130 connecting a gearbox 132 to the rotor shaft 122, and combustion section 126 for burning fuel to generate exhaust used to drive the turbines 110, 112 and propel an aircraft.

Acoustic foam, honeycomb acoustic paneling, and/or metal acoustic paneling are used to suppress some of the noise generated the aircraft engine 101. However, conventional acoustic foam cannot be used in high temperature areas and conventional acoustic paneling requires complicated assembly and installation. Moreover, noise suppression provided by conventional acoustic paneling and acoustic foam is limited. Accordingly, there is a need for continued research and development efforts in the field of noise suppression systems. The present disclosure satisfies this need.

### SUMMARY

Acoustic panels, aircraft including the same, and associated methods are disclosed herein. Illustrative, non-exclusive examples of inventive subject matter according to the present disclosure are described in the following enumerated paragraphs:

A1. A device, comprising:

an acoustic panel including an acoustic property varying as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

A2. The device of paragraph A1, wherein the acoustic signature comprises one or more frequencies and the acoustic property is tuned to attenuate the transmission of the one or more frequencies.

A3. The device of paragraph A2, wherein the acoustic property is tailored with a resolution such that the acoustic panel targets one or more of the frequencies so as to selectively attenuate the one or more of the frequencies with a frequency resolution of less than 10 Hz and across a frequency range from 100 Hz to 7 kHz (e.g., the acoustic property can selectively suppress frequencies that differ by less than 10 Hz).

A4. The device of any of the paragraphs A1-A3, wherein the acoustic panel comprises a plurality of noise attenuating features at different locations across an area of the acoustic panel, each of the noise attenuating features having a diameter and shape and each of the noise attenuating features having the acoustic property tailored by at least one of the diameter or the shape, the at least one of the shape or the diameter tailored at the different locations so as to vary the acoustic property as a function of the position relative the one or more sources.

A5. The device of paragraph A4, wherein the noise attenuating features each comprise a cell, a cavity, or a resonator.

A6. The device of paragraph A4 or A5, wherein the noise attenuating features each comprise a Helmholtz resonator.

A7. The device of any of the paragraphs A4-A7, wherein: the acoustic panel includes:

one or more first regions having a first density of the noise attenuating features, wherein the first density varies as a function of the position in the first region, and

a second region having a second density of the noise attenuating features, wherein the second density is lower than the first density and the second density varies as a function of position within the second region.

A8. The device of any of the paragraphs A4-A8, wherein the acoustic panel comprises 5 of the noise attenuating features in a row, wherein each of the 5 noise attenuating features in the row has a different value for the diameter or a different shape so that the acoustic property is different at each of the 5 noise attenuating features.

A9. The device of any of the paragraphs A4-A8, wherein the acoustic panel includes one or more regions wherein a density of the noise attenuating features varies gradually, continuously, or so that the acoustic property varies as a function of the position with a spatial resolution of less than 10 inches.

A10. The device of any of the paragraphs A4-A9, wherein the noise attenuating features are additively manufactured or molded.

A11. The device of any of the paragraphs A4-A10, wherein the noise attenuating features are in a core of the acoustic panel or are attached to a part comprising the panel and the one or more sources of the acoustic waves.

A12. The device of any of the paragraphs A1-A11, wherein the one or more sources comprise a plurality of distinct subsystems of an aircraft engine and the acoustic property varies locally in the acoustic panel as a function of the position relative to each of the distinct subsystems.

A13. An apparatus, comprising:

a nacelle including the acoustic panel of any of the paragraphs A1-A12; and

a gas turbine engine disposed in the nacelle.

A14. The device of any of the paragraphs A1-A13, wherein the acoustic signature comprises a measured acoustic signature and the acoustic property is tuned to suppress the transmission of the acoustic waves having the measured acoustic signature.

A15. The device of paragraph A14, wherein:

the one or more sources are in a gas turbine engine having a design and the measured acoustic signature is a (e.g., unique or identifying) characteristic of the design, and

the acoustic panel has the acoustic property tailored and/or tuned to attenuate the transmission of the acoustic waves having the measured acoustic signature associated with the design.

B1. A method of making an acoustic panel, comprising:

making the acoustic panel including an acoustic property varying as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

B2. The method of paragraph B1, further comprising: (a) obtaining or measuring the acoustic signature of the one or more sources; and (b) fabricating the acoustic panel tailored to attenuate the acoustic signature obtained or measured in (a).

B3. The method of any of the paragraphs B1-B2, wherein the making comprises additive manufacturing.

B4 The method of any of the paragraphs B1-B3 used to manufacture the acoustic panel of any of the paragraphs A1-A15.

### BRIEF DESCRIPTION OF THE DRAWINGS

Referring now to the drawings in which like reference numbers represent corresponding parts throughout:

FIG. 1 is a cross-sectional schematic of an aircraft engine (gas turbine engine).

FIG. 2 is a perspective view of the engine disposed in a nacelle with an exhaust system and support structure, illustrating positioning of acoustic panels having an acoustic property tailored to suppress noise from the aircraft engine, according to one or more examples described herein

FIG. 3 is a cross-sectional view of a nacelle and inlet including an acoustic panel having a tailored acoustic property according to one or more examples described herein.

FIG. 4 illustrates a thrust reverser assembly comprising a wedge including an acoustic treatment, wherein the acoustic treatment has a tailored acoustic property according to one or more examples described herein.

FIG. 5 is a flowchart illustrating a method of making an acoustic panel or acoustic treatment, according to one or more examples described herein.

FIG. 6A illustrates an additively manufactured part comprising noise attenuating features, according to one or more examples described herein.

FIG. 6B illustrates an acoustic panel including a core sandwiched between face sheets, according to one or more examples described herein.

FIG. 6C illustrates a perspective view of an acoustic panel including a core comprising hexagonal cells, according to one or more examples.

FIG. 6D is a top view of the acoustic panel of FIG. 6C.

FIG. 6E is a cross-sectional view of the acoustic panel of FIG. 6C.

FIG. 7A illustrates an aircraft including an acoustic panel according to one or more examples described herein.

FIG. 7B illustrates a car including an acoustic panel according to one or more examples described herein.

FIG. 7C illustrates a building including an acoustic panel according to one or more examples described herein.

FIG. 8 is a schematic view of a Helmholtz resonator illustrating the parameters used to tune the acoustic property, according to one or more examples described herein.

FIG. 9 is a perspective view of a plurality of Helmholtz resonators in an acoustic panel, according to one or more examples described herein.

FIG. 10A illustrates an acoustic panel including varying densities of Helmholtz resonators tailored to suppress noise from one or more sources of acoustic waves, according to one or more examples described herein.

FIG. 10B illustrates a generic, non-customized acoustic panel having an acoustic property that is not tailored to suppress noise.

FIG. 11 illustrates an example hardware and software environment useful for designing and manufacturing an acoustic panel according to one or more examples described herein.

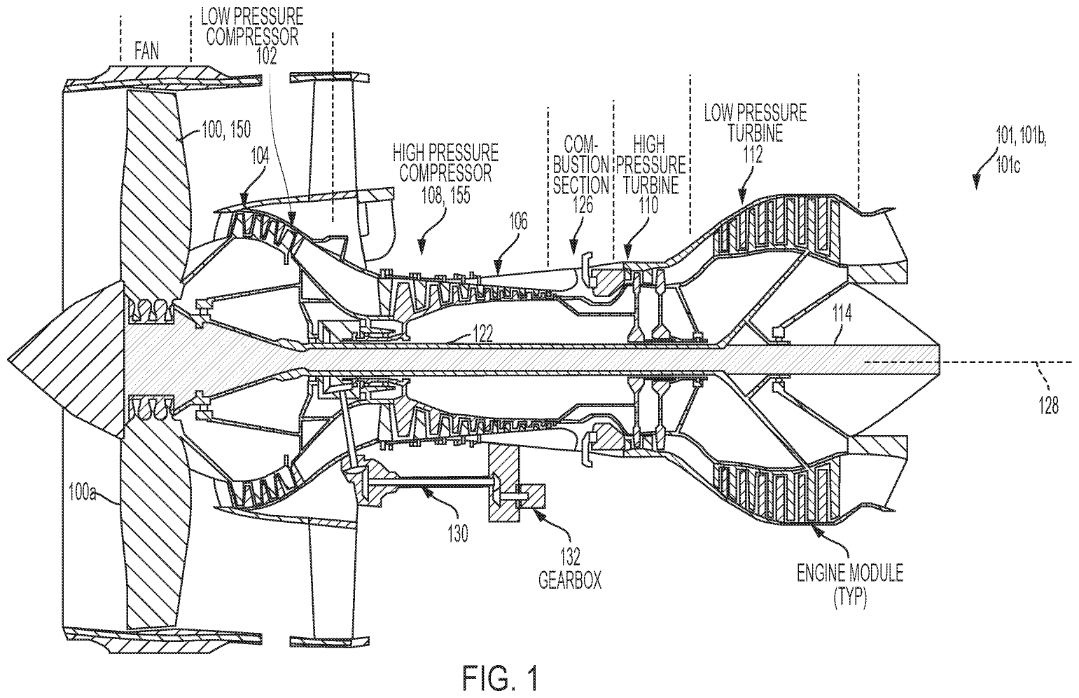

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

Technical Description

The present disclosure describes systems and methods that tailor or more finely tune sound proofing for one or more sources of noise (e.g., an aircraft engine). Examples include a 3D printed acoustic panel comprising a standalone or self-supporting structural component or a component that is combined with another part.

Example: Aircraft Engine Installation

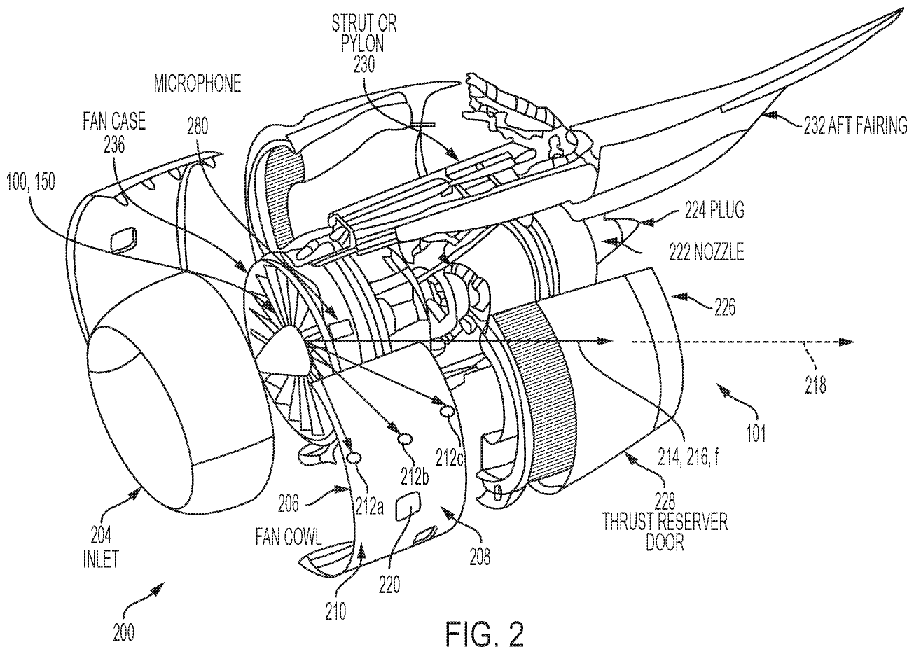

FIG. 2 illustrates an aircraft engine 101 disposed in a nacelle 200, wherein the nacelle includes a fan cowl 206 and an inlet 204. The fan cowl 206 comprises an acoustic panel 208 configured to suppress, attenuate, or cancel noise generated in the aircraft engine 101. The acoustic panel 208 has an acoustic property 210 varying (e.g., commensurately or dynamically) as a function of a position 212a, 212b, 212c in the acoustic panel relative to one or more sources 150 of acoustic waves 214 in acoustic communication with the acoustic panel 208. The acoustic waves 214 have one or more acoustic signatures 216 associated with the one or more sources 150 and the acoustic property 210 is tailored, as a function of the position 212a, 212b, 212c to attenuate transmission 218 of the acoustic waves 214 having the one or more acoustic signatures 216.

In one or more examples, the acoustic signature 216 comprises one or more frequencies f and the acoustic property 210 is tuned to attenuate the transmission 218 of the one or more frequencies. In one or more examples, the acoustic property 210 is tailored with a resolution such that the acoustic panel attenuates the one or more frequencies f with a frequency resolution of less than 10 Hz and across a frequency range from 100 Hz to 7 kHz.

In various examples, the acoustic panel 208 comprises a plurality of noise attenuating features 220, each of the noise attenuating features 220 at the different positions 212a, 212b, 212c across the acoustic panel 208. The acoustic property 210 is tailored by a property or characteristic of the noise attenuating features at the different positions so as to vary the acoustic property as a function of the position relative the one or more sources.

FIG. 2 illustrates an example wherein the acoustic waves emanate or are emitted from the source 150 of noise comprising a fan 100. Other examples of noise sources include, but are not limited to, any distinct subsystem 155 of the aircraft engine so that the acoustic property 210 varies locally in the acoustic panel 208 as a function of the position 212a, 212b, 212c relative to any of the distinct subsystems 155. Examples of the distinct subsystems include, but are not limited to, a low pressure (LP) compressor 102, a fan case 104, an engine casing 106, a High Pressure (HP) compressor 108, a HP turbine 110, a LP turbine 112, an LP shaft 114 connecting the LP compressor 102 and the LP turbine 112, a combustion section 126, or an exhaust system comprising a nozzle 222, a plug 224, and a thrust reverser assembly 226 including blocker door 228.

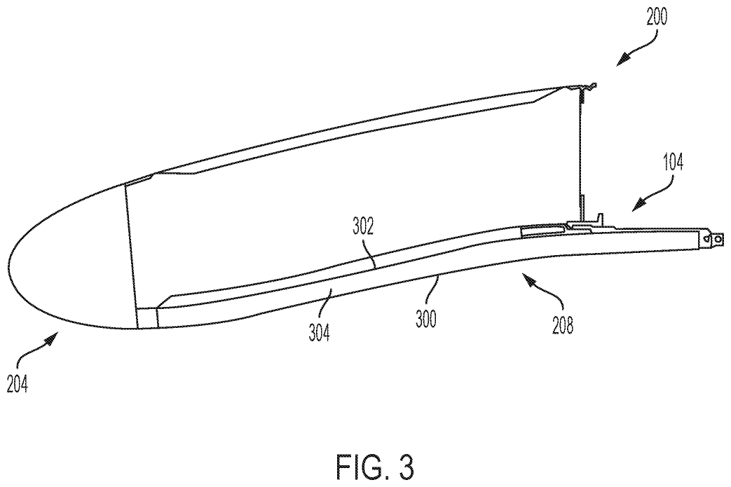

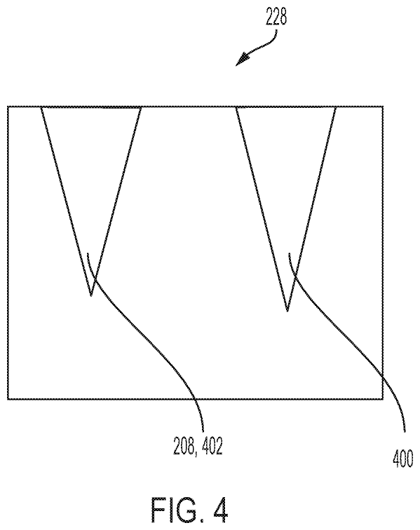

FIG. 2 illustrates an example wherein the fan cowl 206 includes the acoustic panel 208. However, in other non-limiting examples, the acoustic panel 208 comprises or is combined with any part of the aircraft engine assembly comprising the nacelle 200, the exhaust system, or support structure (comprising strut or pylon 230 and aft fairing 232). FIG. 3 illustrates the inlet 204 portion of the nacelle 200 including the acoustic panel 208, wherein the acoustic panel includes a first face sheet 300, a second face sheet 302, and a core 304 (e.g., honeycomb core) sandwiched between first face sheet 300 and the second face sheet 302. FIG. 4 illustrates a thrust reverser assembly 226 comprising a blocker door 228 , wherein the blocker door 228 includes a plurality of wedges 400 each comprising an acoustic panel 208 or acoustic treatment 402.

Example Manufacturing Process

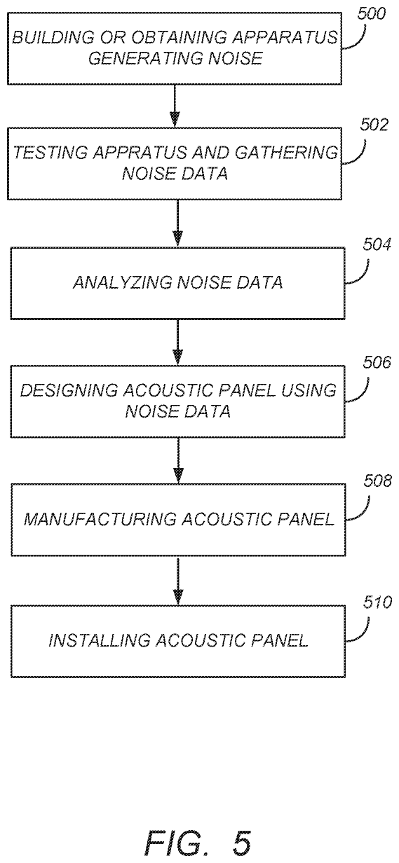

FIG. 5 illustrates a method of making an acoustic panel according to one or more examples.

Block 500 represents building or obtaining an apparatus generating noise (e.g., an aircraft engine 101). The apparatus comprises one or more sources of acoustic waves generating the noise.

Block 502 represents testing the apparatus and gathering noise data associated with the acoustic waves. In one or more examples, the noise data comprises noise as a function of distance or position relative to the apparatus or one or more sources generating the noise. In one or more examples, the noise data comprises amplitude and frequency of the acoustic waves (emitted by the one or more sources) as a function of distance along the longitudinal axis 128 of the aircraft engine and radial distance from the longitudinal axis 128. In one or more examples, the noise data is collected using one or more appropriately positioned microphones (280 in FIG. 2) connected to a computer.

Block 504 represents obtaining and analyzing the noise data to determine one or more acoustic signatures associated with the one or more sources of the acoustic waves. In one or more examples, the acoustic signature comprises one or more frequencies f or one or more amplitudes of the acoustic waves as a function of distance from the one or more sources.

Block 506 represents designing an acoustic panel or acoustic treatment using the noise data, so that the acoustic panel or acoustic treatment suppresses or reduces the noise generated from the apparatus. In one or more examples, the step comprises modifying a baseline design of the acoustic panel or acoustic treatment. An acoustic property (e.g., sound absorption coefficient, sound transmission coefficient, or sound reflection coefficient) of the acoustic panel or acoustic treatment is designed to vary as a function of a position in the acoustic panel relative to the one or more sources of acoustic waves in acoustic communication with the acoustic panel or acoustic treatment, so that the acoustic property is tailored, as a function of the position, to attenuate transmission of the acoustic waves having the one or more acoustic signatures. In one or more examples, the acoustic panel or acoustic treatment comprises noise attenuating features (e.g., a Helmholtz resonator) at different locations in the panel and whose dimensions and shape at the different locations are tailored to vary the acoustic property as a function of the position. In one or more examples, the noise attenuating features are designed to attenuate different frequencies of the acoustic waves.

Block 508 represents manufacturing the acoustic panel or acoustic treatment according to the design. In one or more examples, the acoustic panel and/or the noise attenuating features are additively manufactured or 3D printed using an additive manufacturing machine or 3D printer printing a material layer by layer. In yet further examples, the acoustic panel, acoustic treatment, or the noise attenuating features are molded in a material.

In one or more examples, the manufacturing comprises obtaining a data file including the dimensions and design of the acoustic panel/acoustic treatment including the noise attenuating features, and printing the acoustic panel, the acoustic treatment, and/or the noise attenuating features (or portions thereof) using a 3D printer or additive manufacturing machine controlled by a computer. The computer instructs the machine or 3D printer to print the acoustic panel according to the design and dimensions obtained from the data file.

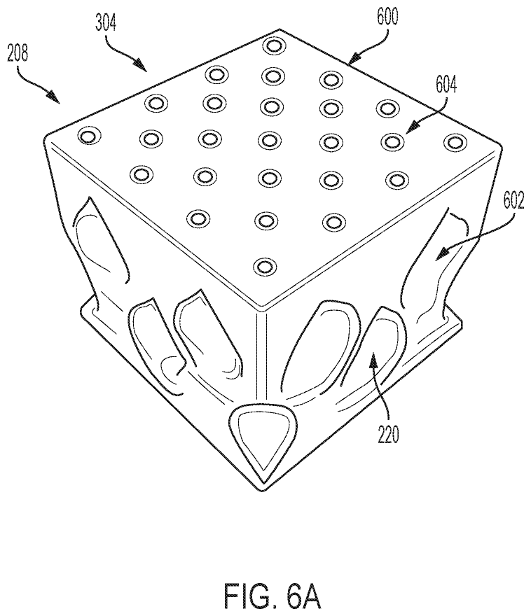

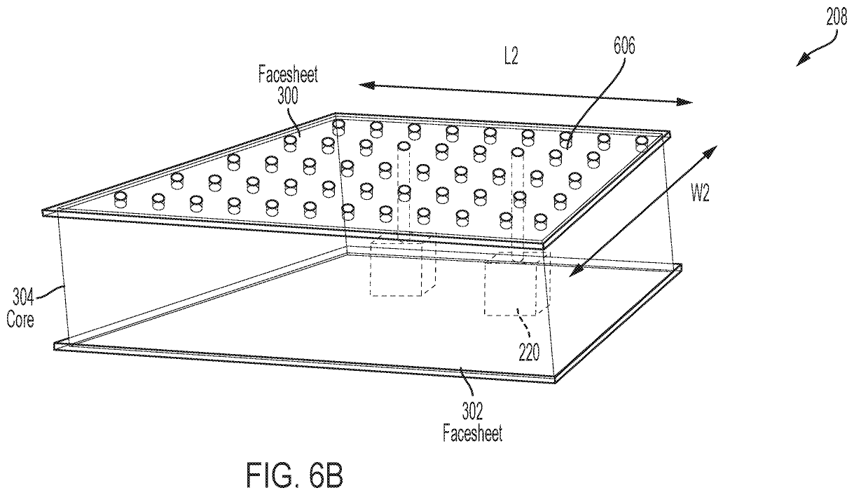

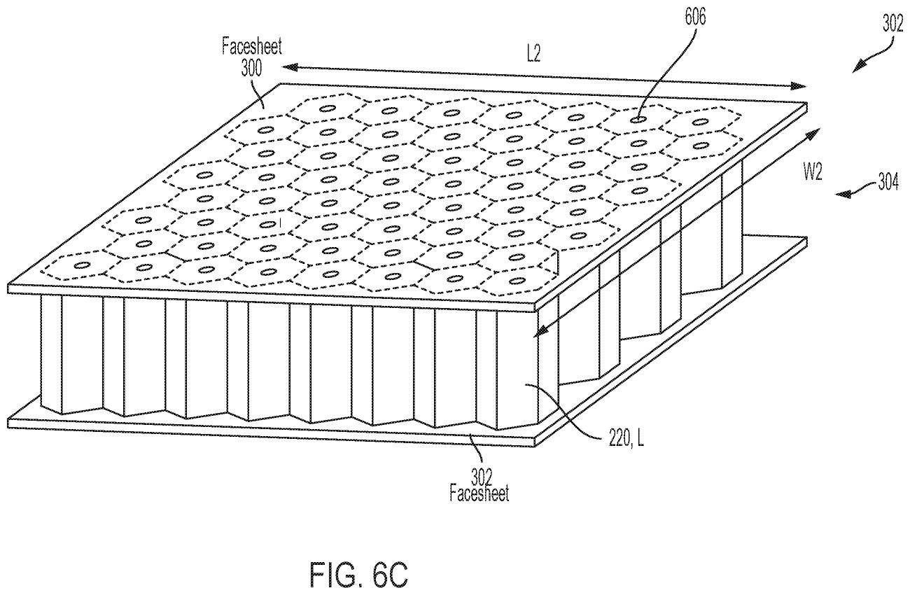

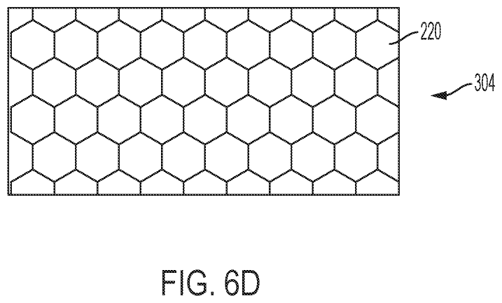

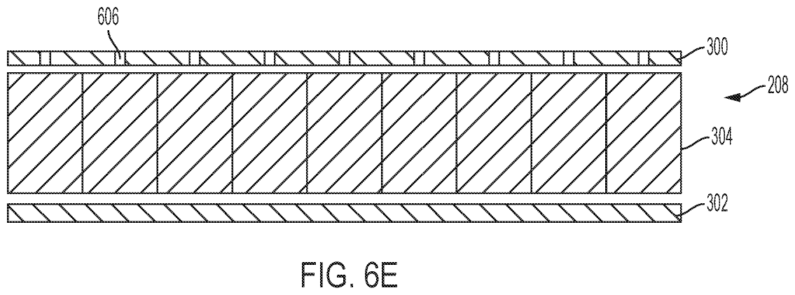

FIG. 6A illustrates an additively manufactured part 600 comprising the entire acoustic panel 208 or acoustic treatment or a core 304 in the acoustic panel 208. The part 600 comprises a plurality of the noise attenuating features 220 (Helmholtz resonators) each including a cavity 602 and an opening 604. In one or more examples, the part 600 includes an structural component (e.g., a wall, door, or frame) and/or a fastener for fastening the part in an assembly. The noise attenuating features each have a dimension (e.g., diameter or width) and shape so that the noise attenuating features have their acoustic property tailored by at least one of the dimension or the shape, the at least one of the shape or the dimension tailored at the different locations so as to vary the acoustic property as a function of the position relative the one or more sources.

FIG. 6B illustrates the acoustic panel 208 comprising the core 304 sandwiched between a first face sheet 300 and a second face sheet 302, wherein the first face sheet 300 comprises perforations 606 coupled to the openings 604 of the noise attenuating features 220.

Example materials for the face sheets include, but are not limited to, metal (e.g., aluminum, titanium) or composite materials comprising fiber tows and/or filaments combined with resin. Example materials for the fiber tows and filaments include, but are not limited to, materials comprising or consisting essentially of, glass, fused silica, fiberglass, metal, carbon fiber, carbon, boron, metal, mineral and polymer, etc. Examples of the polymers include, but are not limited to, thermoplastics, such as polyamide, polyetherketone (PEK), polyether ether ketone (PEEK), polyetherketoneketone (PEKK), Polyetherimide (PEI), or hybrid forms of thermoplastics, with modifiers and/or inclusions such as carbon nanotube(s), graphene, clay modifier(s), discontinuous fiber(s), surfactant(s), stabilizer(s), powder(s) and particulate(s).

In one or more examples, the material printed, deposited or molded to form the core comprises or consists essentially of a thermoplastic or a hybrid of the thermoplastic, e.g., as described above.

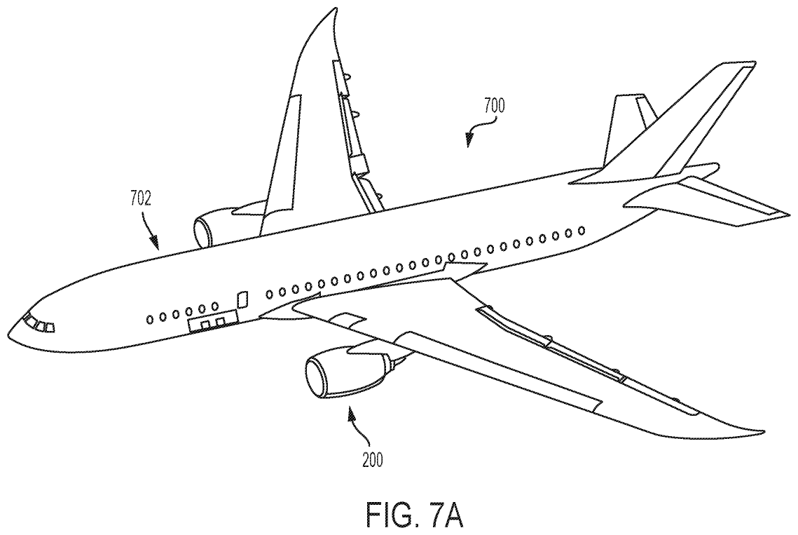

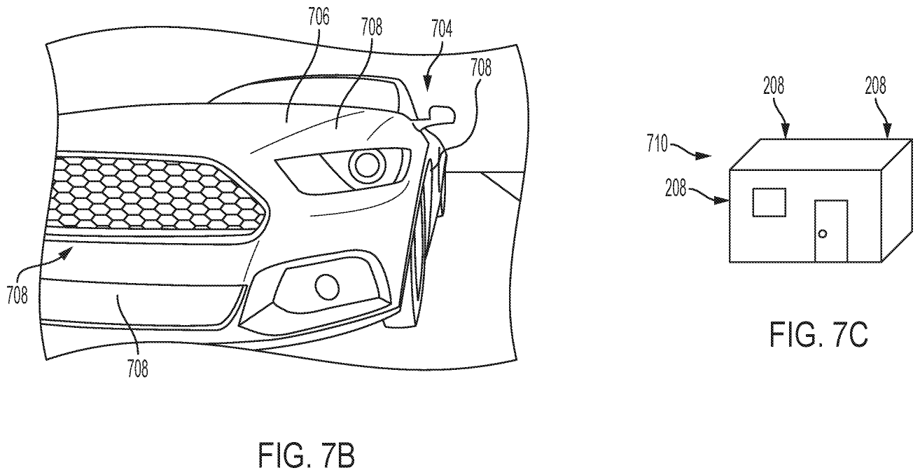

Block 510 represents installing the acoustic panel 208 or acoustic treatment in acoustic communication with the noise generating apparatus during final assembly, so that the acoustic panel or acoustic treatment suppresses, sound proofs, or cancels the noise generated by the apparatus. FIG. 7A illustrates an aircraft 700 including the source comprising an engine 101 propelling the aircraft and the acoustic treatment in the nacelle 200 or other part of the aircraft (e.g., fuselage 702). FIG. 7B illustrates a car 704 including the noise source in the engine compartment or external to the car and the acoustic panel 208 or acoustic treatment in the hood 706 or other paneling 708 on the car 704. Other examples include, but are not limited to, the acoustic panel 208 installed in a building 710 to suppress noise outside or inside the building (as illustrated in FIG. 7C). In one or more examples, the core comprising additively manufactured, 3D printed, or molded material is combined with or embedded into a construction material for the building. In yet another example, the acoustic panel is installed in paneling on a train to suppress noise inside or outside the train.

Example Noise Attenuation Features and Configurations

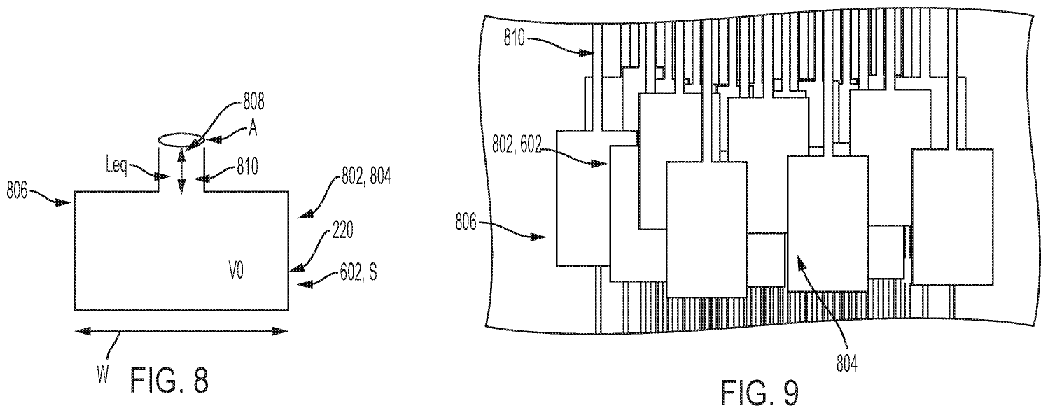

FIG. 8 and FIG. 9 illustrate example noise attenuating features 220 each comprising a cell 802, a cavity 602, or a resonator 804. In FIG. 8 and FIG. 9, the resonator 804 comprises a Helmholtz resonator 806 (also known as a Helmholtz oscillator). A Helmholtz resonator includes the cavity 602 containing a gas (usually air) with an opening 604 (an open hole 808 or a neck 810 with the open hole 808). A volume of air in the neck 810 and/or near or above the open hole 808 vibrates or oscillates in response to the acoustic waves propagating through the volume of air. The oscillation causes damping or suppression of the acoustic waves. Without being bound by a particular scientific theory, in one or more examples, the harmonic frequency f_{H} of the oscillation (modeling the resonator as a harmonic oscillator) is given by:

$${f}_{H} = \frac{v}{2 π} \sqrt{\frac{A}{{V}_{0} {L}_{eq}}}$$

where v is the speed of sound, A is the area of the neck's cross-section, Vo is the volume of the cavity, and Leq is the length of the neck. Adjusting one or more of the resonators's parameters (A, Vo, Leq, or neck diameter or width) allows the harmonic frequency f_{H} of resonator to be fine-tuned so as to suppress the transmission of the acoustic waves transmitted from specific sources of noise (e.g., engines). In one or more examples, the harmonic frequency f_{H} is tuned to suppress one or more frequencies of the acoustic waves. In one or more applications, the frequency f of the acoustic waves varies depending on distance to, or the position 212a, 212b relative to, one or more of the sources of the acoustic waves and the parameters of one or more of the resonators are tuned as a function of the position 212a, 212b or the distance.

Example cross-sectional shapes for the cavity 602 include, but are not limited to, hexagonal, square, circular, or triangular cross-sectional shapes, e.g., so that the cavity 602 has a spherical, cylindrical, cubic, cuboidal, or prismoidal shape (e.g., rectangular prism shape or hexagonal prism shape as illustrated in FIGS. 6C-6E).

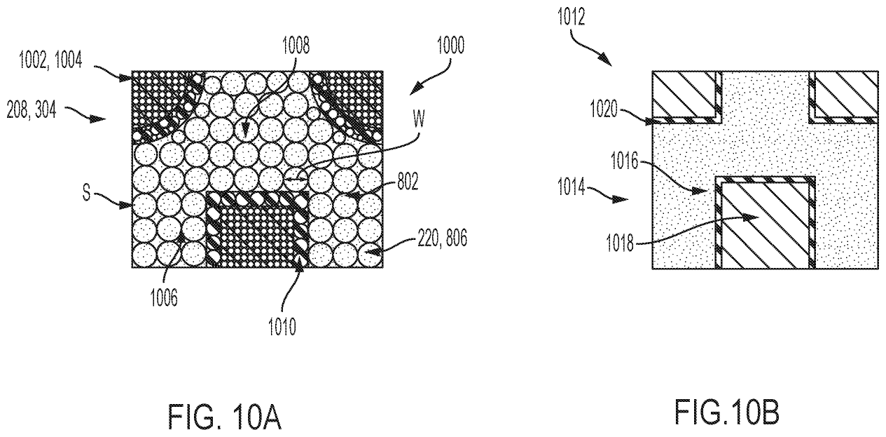

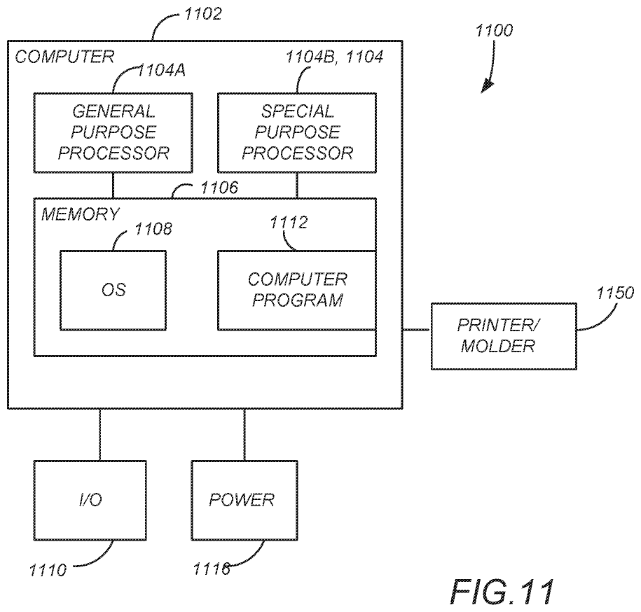

FIG. 10A illustrates the noise attenuating features 220 having a dimension (diameter or width W) and shape S and an acoustic property tailored by at least one of the diameter or the shape. The at least one of the shape or the diameter are tailored so as to vary the acoustic property as a function of the position 212a, 212b relative the one or more sources 150. In FIG. 10A, an example area 1000 of the acoustic panel 208 includes one or more first regions 1002 having a first density 1004 of the noise attenuating features 220, wherein the first density varies as a function of the position in the first region. The acoustic panel further comprises a second region 1006 having a second density 1008 of the noise attenuating features wherein the second density is lower than the first density and the second density varies as a function of position within the second region. FIG. 10A further illustrates interfacial regions 1010 between the first region 1002 and the second region 1006 wherein the density of noise attenuating features 220 varies gradually (rather than abruptly) between the first density and the second density. Thus, in various examples, the acoustic panel 208 includes one or more regions 1002, 1010, 1006 wherein a density of the noise attenuating features varies gradually, continuously, or with a spatial resolution of less than 10 inches within and/or between each of the one or more regions.

In one or more examples, one or more of the parameters (diameter, shape, A, Vo, Leq, or neck diameter or width) are tuned for each of the individual noise attenuating features so that the acoustic property (e.g., absorption, transmission, or reflection as a function of frequency) is tailored or tuned with a spatial resolution corresponding to, or comprising, or consisting essentially of, an area of one or more of the noise attenuating features. Examples include, but are not limited to, the acoustic panel comprising a plurality (e.g., at least 2, 3, 5, 10) of the noise attenuating features in a row, wherein each of the plurality of the noise attenuating features in the row has a different diameter or a different shape so that the acoustic property is different at each of the plurality of the noise attenuating features. In one or more examples, the noise attenuating features include individual noise attenuating features or sets of the noise attenuating features having their dimension and/or shape tailored so that the acoustic property is tailored to suppress the frequencies across the entire frequency range from 100 Hz to 7 kHz or any subset of frequencies within the range. For example, the noise attenuating include different sets of one or more noise attenuating features, wherein each of the different sets comprise one or more noise attenuating features configured or tailored to attenuate a different subset of the frequencies in the range of 100 Hz to 7 kHz, so that the acoustic panel has a broadband frequency response suppressing all or any desired frequencies in any desired range of frequencies (e.g., all or any desired frequencies in the range of 100 Hz to 7 kHz).

For comparison, FIG. 10B illustrates an acoustic paneling 1012 having an acoustic property that is not tailored or fine tuned to suppress the unique acoustic signatures as a function of position relative to the sources of the acoustic waves. The acoustic paneling 1012 includes a honeycomb core 1014 comprising a low density region 1016 of cells (e.g. Helmholtz resonators) spliced to a higher density region 1018 of cells, but the dimensions of the cells do not vary within the high density region or the lower density region so that the acoustic paneling's acoustic property is generic to a wide range of sources of acoustic waves rather than being customized, tuned, or tailored to a specific source of acoustic waves or positioning relative to the sources. Moreover, an interface 1020 between the higher density region 1018 and the lower density region 1016 in the example of FIG. 10B is abrupt and does not allow for a gradual variation in the density of cells as illustrated in FIG. 10A. Furthermore, since density and dimensions of the cells in FIG. 10B are consistent over large areas, the acoustic paneling can only attenuate small ranges of frequencies of the acoustic waves.

### Further Examples

Illustrative, non-exclusive examples of inventive subject matter according to the present disclosure are described in the following enumerated paragraphs:

A1. A device, comprising:

an acoustic panel (208) including an acoustic property (210) varying (e.g., commensurately) as a function of a position (212a, 212b, 212c) in the acoustic panel (208) relative to one or more sources (150) of acoustic waves (214) in acoustic communication with the acoustic panel (208), the acoustic waves (214) having one or more acoustic signatures (216) associated with the one or more sources (150), wherein the acoustic property (210) is tailored, as a function of the position (212a, 212b, 212c), to attenuate transmission (218) of the acoustic waves (214) having the one or more acoustic signatures (216), e.g., so as to cancel the noise emitted from the one or more sources.

A2. The device of paragraph A1, wherein the acoustic signature (216) comprises one or more frequencies (f) and the acoustic property (210) is tuned to attenuate the transmission (218) of the one or more frequencies (f).

A3. The device of paragraph A2, wherein the acoustic property (210) is tailored with a resolution such that the acoustic panel (208) targets one or more of the frequencies (f) so as to selectively attenuate the one or more of the frequencies with a frequency resolution of less than 10 Hz and across a frequency range from 100 Hz to 7 kHz (e.g., the acoustic property can selectively suppress frequencies that differ by less than 10 Hz). In one or more examples, the acoustic property is tailored to suppress the frequencies across the entire frequency range from 100 Hz to 7 kHz or any subset of frequencies within the range.

A4. The device of any of the paragraphs A1-A3, wherein the acoustic panel (208) comprises a plurality of noise attenuating features (220) at different locations (L) across an area (1000) of the acoustic panel (208), each of the noise attenuating features (220) having a size (e.g., diameter or width W) and shape S and each of the noise attenuating features (220) having the acoustic property (210) tailored by at least one of the size or the shape (S), the at least one of the shape (S) or the size tailored at the different locations (L) so as to vary the acoustic property (210) as a function of the position (212a) relative the one or more sources (150).

A5. The device of paragraph A4, wherein the noise attenuating features (220) each comprise a cell (802), a cavity (602), or a resonator (804).

A6. The device of paragraph A4 or A5, wherein the noise attenuating features (220) each comprise a Helmholtz resonator (804).

A7. The device of any of the paragraphs A4-A7, wherein:

the acoustic panel (208) includes:
one or more first regions (1002) having a first density (1004) of the noise attenuating features (220), wherein the first density (1004) varies as a function of the position (212a, 212b, 212c) in the first region (1002), and
a second region (1006) having a second density (1008) of the noise attenuating features (220), wherein the second density (1008) is lower than the first density (1004) and the second density (1008) varies as a function of the position (212a, 212b, 212c) within the second region (1006).

A8. The device of any of the paragraphs A4-A8, wherein the acoustic panel (208) comprises 5 of the noise attenuating features (220) in a row, wherein each of the 5 noise attenuating features (220) in the row has a different value for the diameter (W) or a different shape (S) so that the acoustic property (210) is different at each of the 5 noise attenuating features (220).

A9. The device of any of the paragraphs A4-A8, wherein the acoustic panel (208) includes one or more regions (1002, 1006, 1010) wherein a density of the noise attenuating features (220) varies gradually, continuously, or so that the acoustic property (210) varies as a function of the position (212a, 212b, 212c) with a spatial resolution of less than 10 inches.

A10. The device of any of the paragraphs A4-A9, wherein the noise attenuating features (220) are additively manufactured or molded.

A11. The device of any of the paragraphs A4-A10, wherein the noise attenuating features (220) are in a core (304) of the acoustic panel (208) or are attached to a part (600) comprising the panel (208) and the one or more sources (150) of the acoustic waves (214).

A12. The device of any of the paragraphs A1-A11, wherein the one or more sources (150) comprise a plurality of distinct subsystems (155) of an aircraft engine (700) and the acoustic property (210) varies locally in the acoustic panel (208) as a function of the position (212a, 22b, 212c)relative to each of the distinct subsystems (155).

A13. An apparatus, comprising:

a nacelle (200) including the acoustic panel (208) of any of the paragraphs A1-A12; and

a gas turbine engine (101) comprised of one or more of the sources (150) disposed or housed in the nacelle (200).

A14. The device of any of the paragraphs A1-A13, wherein the acoustic signature comprises a measured acoustic signature (216) and the acoustic property is (210) tuned to suppress the transmission (218) of the acoustic waves (214) having the measured acoustic signature (216).

A15. The device of paragraph A14, wherein:

the one or more sources (150) are in an apparatus (101b) having a design (101c) and the measured acoustic signature (216) is a (e.g., unique or identifying) characteristic of the design, and

the acoustic panel (208) has the acoustic property (210) tailored and/or tuned to attenuate the transmission (218) of the acoustic waves (214) having the measured acoustic signature (216) associated with the design (101c).

A16. The device of paragraph A15, wherein the design is identified from other designs or specifications using an identifier (e.g., part number, serial number, family name, series name, model name, model number, brand name, company name, or manufacturer name) so that the acoustic panel has the acoustic property tailored to suppress or reduce noise or the acoustic waves generated in an apparatus identified by the identifier.

A17. The device of paragraph A16, wherein the acoustic property is tailored and/or tuned to suppress the acoustic waves more effectively (e.g., increased suppression or more noise cancellation) as compared to the acoustic waves generated in the apparatus identified by a different one of the identifiers.

A18. The device of paragraph A17, wherein the acoustic signature is measured for each of a plurality of designs (having different identifiers) for the apparatus and the acoustic panel is manufactured with the acoustic property designed and tailored using the measured acoustic signature.

A19. The device of any of the paragraphs A15-A18, wherein the apparatus is a gas turbine engine, e.g., for powering an aircraft.

A20. The device of paragraph A19, wherein the different designs having different acoustic signatures comprise a two spool gas turbine engine and a three spool gas turbine engine.

A21. The device of paragraph A19, wherein the different designs having different acoustic signatures comprise a geared turbofan engine where a gearbox (e.g., planetary reduction gearbox) or transmission is disposed between the low pressure shaft and the fan and a direct drive turbofan engine where there is no gearbox or transmission between the low pressure shaft and the fan.

A22. The device of paragraph A19, wherein the different designs having different acoustic signatures comprise a gas turbine engine powering a regional jet and a gas turbine engine powering a long haul jet or medium range jet.

A23. The device of paragraph A19, wherein the different designs comprise gas turbine engines generating different amounts of thrust that differ by 10% or less.

A24. The device of paragraph A19, wherein the different designs comprise acoustic signatures having peak frequencies that differ by less than 10 Hz.

A25. The device of any of the paragraphs A1-A24, wherein the acoustic signature describes a combination of acoustic emissions or acoustic waves generated from the one or more sources in a machine, and the acoustic signature is a (e.g., unique) characteristic or attribute usable to identify the machine or study the machine's condition, behavior, or physical location.

A26. The device of any of the paragraphs A1-A25, wherein the acoustic panel has the acoustic property fine-tuned to suppress one or more specific frequencies of the acoustic waves generated by a custom or unique source (e.g., unique aircraft engine).

A27. The device of any of the paragraphs A1-A26, wherein the acoustic panel comprises the varying acoustic property suppressing or reducing the noise comprising the acoustic waves originating from one or more sources in an aircraft engine or other area of an aircraft or airplane.

A28. The device of any of the paragraphs A1-A27, wherein the acoustic panel comprises or consists essentially of a standalone or self-supporting structural component or a core that is bonded into a part.

A29. The device of any of the paragraphs A1-A28, wherein the acoustic panel comprises a single part that does not need to be assembled or generally placed within a structure or bonded surface.

B1. A method of making an acoustic panel, comprising:

making the acoustic panel including an acoustic property varying as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

B2. The method of paragraph B1, further comprising: (a) obtaining or measuring the acoustic signature of the one or more sources; and (b) fabricating the acoustic panel tailored to attenuate the acoustic signature obtained or measured in (a).

B3. The method of any of the paragraphs B1-B2, wherein the making comprises additive manufacturing.

B4. The method of paragraph B3, wherein the additive manufacturing the acoustic panel enables the acoustic panel to be fabricated with reduced weight and to have a frequency response customized to a source (e.g., engine) of noise.

B5. The method of any of the paragraphs B3-B4, wherein the acoustic panel has a lower mass as compared to an acoustic panel that is not 3D printed or is not manufactured by additive manufacturing.

B6 The method of any of the paragraphs B1-B5, wherein the acoustic panel is fully additively manufactured panel, enabling the design the noise attenuating features within the acoustic panel that reduce or remove any desired frequency or target multiple frequencies for reduction within the same acoustic panel.

B7. A method of making an acoustic panel, comprising:

receiving, measuring, or obtaining noise data from each of a plurality of individual or unique sources of acoustic waves; identifying variations or differences in the characteristics of the acoustic waves (acoustic signatures) generated from the different sources and using the variations or differences to manufacture a plurality of custom acoustic panels each customized or tailored to provide (e.g., the highest or higher level of) noise cancellation for each of the individual or unique sources.

B8. The method of paragraph B7, wherein each of the plurality of the custom acoustic panels are additively manufactured and have their acoustic property custom tuned to suppress or remove specific frequencies of the acoustic waves generated by the individual or unique sources. The combination of the additive manufacturing and the custom tuning enables the plurality of the custom acoustic panels to be manufactured with a higher level of noise cancelation than could be otherwise obtained without the additive manufacturing or the custom tuning.

B9. The method of any of the paragraphs B1-B8, wherein the acoustic panel comprises a core having the acoustic property custom tuned to suppress the specific frequencies.

B10. The method of any of the paragraphs B1-B9, further comprising manufacturing the core or the acoustic panel including a structural attachment, e.g., a fastener for fastening the acoustic panel in an assembly, thereby reducing the number of parts needed during the assembly of the acoustic panel in a noise cancellation application.

B11. The method of any of the paragraphs B1-B10, further comprising installing (e.g., bonding or attaching) the core directly on or into a part to reduce noise emitted from the source in the part.

B12. The method of any of the paragraphs B1-B11, wherein the sources are in an aircraft engine and the noise data is engine data.

B13 The method of any of the paragraphs B1-B12 used to manufacture the acoustic panel of any of the paragraphs A1-A29.

Processing Environment

FIG. 11 illustrates an exemplary system 1100 used to implement processing elements needed to control the machine 1150 (e.g., 3D printer) used to manufacture the acoustic panel, design the acoustic panel, or analyze the noise data from the noise sources.

The computer 1102 comprises a processor 1104 (general purpose processor 1104A and special purpose processor 1104B) and a memory, such as random access memory (RAM) 1106. Generally, the computer 1102 operates under control of an operating system 1108 stored in the memory 1106, and interfaces with the user/other computers to accept inputs and commands (e.g., analog or digital signals) and to present results through an input/output (I/O) module 1110. The computer program application 1112 accesses and manipulates data stored in the memory 1106 of the computer 1102. The operating system 1108 and the computer program 1112 are comprised of instructions which, when read and executed by the computer 1102, cause the computer 1102 to perform the operations herein described. In one embodiment, instructions implementing the operating system 1108 and the computer program 1112 are tangibly embodied in the memory 1106, thereby making one or more computer program products or articles of manufacture capable of controlling the 3D printer or additive manufacturing machine 1150 so as to fabricate parts according to the methods described herein, or analyze the noise data to determine the acoustic signatures and design the acoustic panel having the tailored acoustic property. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

Conclusion

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A device, comprising:
an acoustic panel including an acoustic property varying commensurately as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

2. The device of claim 1, wherein the acoustic signature comprises one or more frequencies and the acoustic property is tuned to attenuate the transmission of the one or more frequencies.

3. The device of claim 2, wherein the acoustic property is tailored with a spatial resolution such that the acoustic panel targets one or more of the frequencies so as to selectively attenuate the one or more of the frequencies with a frequency resolution of less than 10 Hz and across a frequency range from 100 Hz to 7 kHz.

4. The device of claim 1, wherein the acoustic panel comprises a plurality of noise attenuating features at different locations across an area of the acoustic panel, each of the noise attenuating features having a diameter and shape and each of the noise attenuating features having the acoustic property tailored by at least one of the diameter or the shape, the at least one of the shape or the diameter tailored at the different locations so as to vary the acoustic property as a function of the position relative the one or more sources.

5. The device of claim 4, wherein the noise attenuating features each comprise a cell, a cavity, or a resonator.

6. The device of claim 4, wherein the noise attenuating features each comprise a Helmholtz resonator.

7. The device of claim 4, wherein:
the acoustic panel includes:
one or more first regions having a first density of the noise attenuating features, wherein the first density varies as a function of the position in the first region, and
a second region having a second density of the noise attenuating features, wherein the second density is lower than the first density and the second density varies as a function of the position within the second region.

8. The device of claim 4, wherein the acoustic panel comprises 5 of the noise attenuating features in a row, wherein each of the 5 noise attenuating features in the row has a different value for the diameter or a different shape so that the acoustic property is different at each of the 5 noise attenuating features.

9. The device of claim 4, wherein the acoustic panel includes one or more regions wherein a density of the noise attenuating features varies gradually, continuously, or so that the acoustic property varies as a function of the position with a spatial resolution of less than 10 inches.

10. The device of claim 4, wherein the noise attenuating features are additively manufactured.

11. The device of claim 10, wherein the noise attenuating features are in a core of the acoustic panel or are attached to a part comprising the panel and the one or more sources of the acoustic waves.

12. The device of claim 1, wherein the one or more sources comprise a plurality of distinct subsystems of an aircraft engine and the acoustic property varies locally in the acoustic panel as a function of the position relative to each of the distinct subsystems.

13. An apparatus, comprising:
a nacelle including the acoustic panel of claim 1; and
a gas turbine engine disposed in the nacelle, wherein the gas turbine engine comprises the one or more sources.

14. The device of claim 1, wherein the acoustic signature comprises a measured acoustic signature and the acoustic property is tuned to suppress the transmission of the acoustic waves having the measured acoustic signature.

15. The device of claim 14, wherein:
the one or more sources are in a gas turbine engine having a design and the measured acoustic signature is a characteristic of the design, and
the acoustic panel has the acoustic property tailored or tuned to attenuate the transmission of the acoustic waves having the measured acoustic signature associated with the design.

16. A method of making an acoustic panel, comprising:
making the acoustic panel including an acoustic property varying as a function of a position in the acoustic panel relative to one or more sources of acoustic waves in acoustic communication with the acoustic panel, the acoustic waves having one or more acoustic signatures associated with the one or more sources, wherein the acoustic property is tailored, as a function of the position, to attenuate transmission of the acoustic waves having the one or more acoustic signatures.

17. The method of claim 16, further comprising:
(a) obtaining or measuring the acoustic signature of the one or more sources; and
(b) fabricating the acoustic panel tailored to attenuate the acoustic signature obtained or measured in (a).

18. The method of claim 16, wherein the making comprises forming a plurality of noise attenuating features at different locations across an area of the acoustic panel, each of the noise attenuating features having a diameter and shape and each of the noise attenuating features having their acoustic property tailored by at least one of the diameter or the shape, the at least one of the shape or the diameter tailored at the different locations so as to vary the acoustic property as a function of the position.

19. The method of claim 18, wherein the forming comprises additively manufacturing the noise attenuating features.

20. The method of claim 19, wherein:
the noise attenuating features each comprise a Helmholtz resonator, and
the one or more sources comprise a plurality of distinct subsystems of an aircraft engine, and the acoustic property varies in the acoustic panel as a function of the position relative to each of the distinct subsystems.
